(19) United States
(12) Patent Application Publication
(10) Pub. No.: US 2009/0308799 A1
(43) Pub. Date: Dec. 17, 2009

(54) Water filter housing cap

(76) Inventor: Keuk Rae Cho, Suwon City (KR)

Correspondence Address: BERLINER & ASSOCIATES, 555 WEST FIFTH STREET, 31ST FLOOR, LOS ANGELES, CA, 90013, US

(21) Appl. No.: 11/919,313

(22) PCT Filed: Apr. 20, 2006
(86) PCT No.: PCT/KR2006/001484

§ 371 Date: Oct. 26, 2007

(30) Foreign Application Priority Data
Apr. 28, 2005 (KR) 20-2005-0011963

(51) Int. Cl. B01D 35/30

(52) U.S. Cl. 210/232

(57) ABSTRACT

A filter housing cap for water purifier capable of combining and supporting a plurality of filters is disclosed. The filter housing cap for water purifier includes a plurality of engagement portions for engaging with housings having a filter, an inlet for water and an outlet for water formed at any one engagement portion and another engagement portion respectively, and a passage reciprocally communicated with the engagement portions and formed at the cap itself, whereby the shape and the manufacturing process thereof is simple. Also, since the passage is formed in the cap itself, separated parts are unnecessary and a water leakage can be prevented. Moreover, the engagement portions can be arranged at various angles such as a straight line, a right angle and so on, so that it can implement the integrated filter housing cap, thereby it is free from restraint of a establishment space.

### TECHNICAL FIELD

The present invention relates to a filter housing cap for water purifier, and more particularly to a filter housing cap for water purifier capable of combining and supporting a plurality of filters.

### BACKGROUND ART

Conventionally, in the inside of the water purifier, filters for filtering an original water such as a deposit filter, a pre carbon filter, a post carbon filter and so on are provided. The filters are communicated with each other by means of a pipe and fixed through a separate fixture. As result of this, there are defects in that the manufacturing cost is increased and the water is leaked through a connection part owing to the complicated manufacturing process and many parts thereof.

In order to solve the above defects, a filter assembly of the water purifier for easily assembling the filters is disclosed in Korean utility model registration No. 191316.

FIG. 1 is a sectional view illustrating the conventional filter assembly of the water purifier disclosed in the Korean utility model.

As shown in the conventional filter assembly 10 includes an inlet for water 11a, an outlet for water 11b, a connection pipe 11 having a passage 11c therein, and a plurality of ring-shape projections 13 communicated with the connection pipe 11 and combined with filters 20.

Also, gate ways 15 for discharging the original water flowed from the inlet 11a toward the filters 20 are formed at the connection pipe regions, which are located at the inside of each ring-shape projection 13. The original water flowed into the filter 20 through the gateway 15 is re-flowed into the passage 11c through a connection hole (not shown) formed at the connection pipe 11.

Moreover, a plurality of interception plates 17 is formed at the inside of the passage 11c. The plurality of interception plates 17 serves to divide the inside of the passage 11c into several parts, so that the original water flowed from the inlet 11a passes through the filters 20 and then, discharges into the outlet for water 11b.

In the conventional filter assembly 10, the filter 20 can be easily coupled and fixed thereto. However, it is difficulty to manufacture on account of the complicated structure thereof.

Also, it is difficulty to divide the passage 11c by means of the plurality of interception plates 17 inserted into the inside of the passage 11c. Moreover, there is a concern in that the interception plate 17 may be separated from the inside of the passage 11c.

Furthermore, it should be formed in a straight line for molding it and inserting the interception plates 17 into the passage 11c. Hence, since the filter assembly 10 must be manufactured only in a straight arrangement, there is a defect in that it is restricted by an establishment space owing to a long length thereof.

### DISCLOSURE OF INVENTION

### Technical Problem

Accordingly, the present invention has been made to solve the above-mentioned problems occurring in the prior art, and an object of the present invention is to provide a filter housing cap for water purifier, in that it can be easily manufactured and prevent a water leakage as well as it is free from restraint of a establishment space.

### Technical Solution

To accomplish the objects, the present invention provides a filter housing cap for water purifier comprising: a body coupled to a water purifier body; a plurality of engagement portions formed at one surface of the body coupled to the water purifier body and attached and deattached to housings having a filter, respectively; an inlet formed at the body coupled to the water purifier body in such a manner that it is communicated with any one engagement portion among the engagement portions and an original water is guided and flowed to the filter of the housing coupled to said any one engagement portion; a passage formed at the body coupled to the water purifier body in such a manner that one side thereof is communicated with said any one engagement portion, another side thereof is communicated with another engagement portion, and the original water, which is passed through the filter of the housing coupled to said any one engagement portion, is guided and flowed to the filter coupled to said another engagement portion; and an outlet formed at the body coupled to the water purifier body in such a manner that it is communicated with said another engagement portion and the original water, which is passed through the filter of the housing coupled to said another engagement portion, is guided and discharged to an usage place.

Preferably, the passage comprises an extension passage extending from said any one engagement portion upward and a connection passage for connecting the extension passage to said another engagement portion.

Preferably, the passage comprises a first extension passage extending from said any one engagement portion upward, a second extension passage extending from said another engagement portion upward, and a connection passage for connecting the first extension passage to the second extension passage.

### ADVANTAGEOUS EFFECTS

As can be seen from the foregoing, the filter housing cap for water purifier includes the plurality of engagement portions for engaging with housings having the filter, the inlet for water and the outlet for water formed at any one engagement portion and another engagement portion respectively, and the passage reciprocally communicated with the engagement portions and formed at the cap itself, whereby the shape and the manufacturing process thereof is simple.

Also, since the passage is formed in the cap itself, the separated parts are unnecessary and the water leakage can be prevented.

Moreover, the engagement portions can be arranged at various angles such as a straight line, a right angle and so on, so that it can implement the integrated filter housing cap, whereby it is free from restraint of the establishment space.

### BRIEF DESCRIPTION OF THE DRAWINGS

The above as well as the other objects, features and advantages of the present invention will be more apparent from the following detailed description taken in conjunction with the accompanying drawings, in which:

FIG. 1 is a sectional view illustrating a conventional filter assembly of the water purifier;

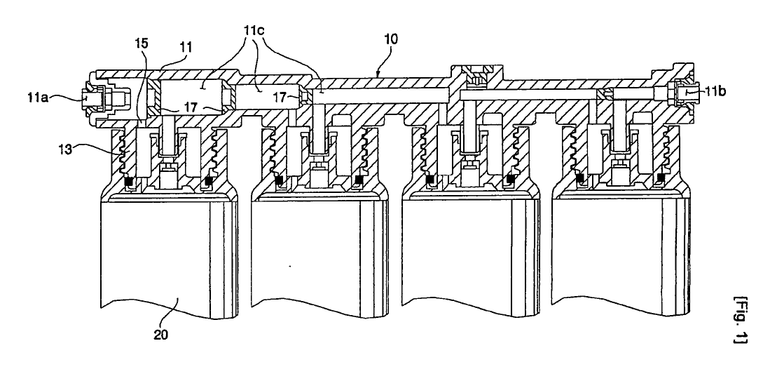

FIG. 2 is a sectional view illustrating a filter housing cap for water purifier according to one embodiment of the present invention;

FIG. 3 is a sectional view illustrating a filter housing cap for water purifier according to a second embodiment of the present invention;

FIG. 4 is a sectional view illustrating a filter housing cap for water purifier according to a third embodiment of the present invention; and

FIG. 5 is a planar view illustrating a filter housing cap for water purifier according to a fourth embodiment of the present invention.

### BEST MODE FOR CARRYING OUT THE INVENTION

A preferred embodiment of the invention will be described in detail below with reference to the accompanying drawings.

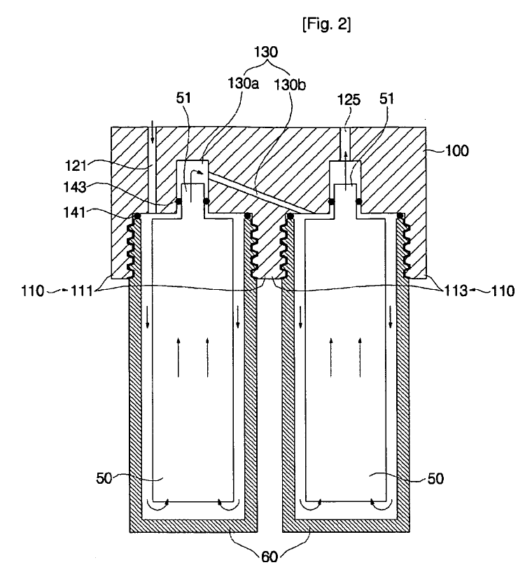

FIG. 2 is a sectional view illustrating a filter housing cap for water purifier according to one embodiment of the present invention.

As shown in FIG. 2, the filter housing cap for water purifier according to one embodiment of the present invention includes a body 100 coupled to a water purifier body, a plurality of engagement portions 110 formed at the body 100. Here, each housing 60 having a filter 50 is coupled to the engagement portions 110.

The opposed tooth, which are formed at inner circumference surfaces of each engagement portion 110 and outer circumference surfaces of upper side portions of each housing 60, are engaged with each other. In a state that the upper side portion of the housing 60 is slightly inserted into the engagement portion 110, the housing 60 is positively rotated, thereby the housing 60 is coupled to the engagement portion 110 and the housing 60 is reversely rotated, thereby the housing 60 is separated from the engagement portion 110. Accordingly, the housing 60 can be easily attached and deattached to the engagement portion 110. Also, the housing 60 may be directly coupled to the engagement portion 110 by using a separate tool without forming the tooth at the housing 60 and the engagement portion 110.

In the inside of the housing 60, a filter 50 for filtering an original water such as a deposit filter, a pre carbon filter, a post carbon filter and so on is built in and coupled to the cap 100. Further description on this will be described later.

In one side of the body 100, an inlet 121 is formed and communicated with any one engagement portion 111 among the engagement portions 110. The original water is flowed into the inlet 121. Here, the original water flowed into the inlet 121 is flowed into the filter 50, which is built in the housing 60 coupled to the engagement portion, in order and then, passed through the filter 50 to be discharged.

In another side of the body 100, an outlet 125 is formed and communicated with another engagement portion 113 among the engagement portions 110. The purified water is passed through the inside of any one engagement portion 111 and another engagement portion 113 and the outlet 125 to be discharged. That is, the outlet 125 serves to guide and discharge the purified water to the usage place

Also, a passage 130 is formed at one side of the body 100 and allows each engagement portion 111 and 113 to be communicated with each other. The passage 130 includes one side communicated with any one engagement portion 111 and the other side communicated with another engagement portion 113. The original water, which is passed through the filter 50 coupled to any one engagement portion 111, is flowed and guided to the inside of the filter 50 coupled to another engagement portion 113.

The passage 130 further includes an extension passage 130a extending from any one engagement portion 111 upward and a connection passage 130b slanted on the body 100 and allowing the extension passage 130a and another engagement portion 113 to be connected to each other.

Also, a protrusion 51 is formed at the upper end portion of the filter 50 and inserted into the extension passage 130a. Accordingly, it is preferred that the shape of the extension passage 130a of the passage 130 corresponds to that of the protrusion 51. Also, since the protrusion 51 of the filter 50, which is coupled to another engagement portion 113 communicated with the outlet 125, is inserted into the outlet 125, the shape of the outlet 125 corresponds to that of the protrusion 51 of the filter 50.

As described above, the filter housing cap for water purifier according to one embodiment of the present invention includes the plurality of engagement portions 110, inlet 121 and outlet 125 formed at any one engagement portion 111 and another engagement portion 113, respectively, and a passage for allowing any one engagement portion 111 and another engagement portion 113 to be communicated with each other. Accordingly, the shape thereof is simple.

The connection passage 130b may be upwardly or downwardly slanted on the body 100. Also, reference numerals 141 and 143 are O-rings.

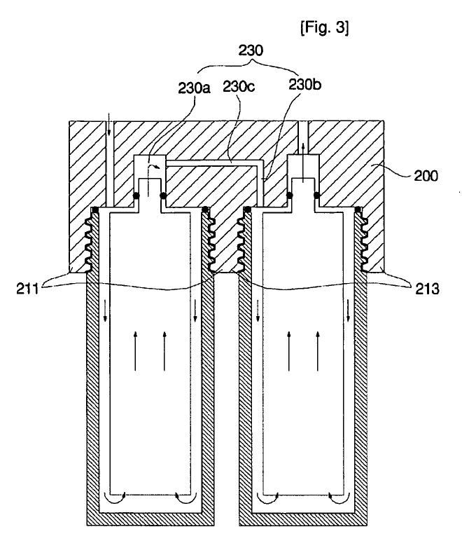

FIG. 3 is a sectional view illustrating a filter housing cap for water purifier according to a second embodiment of the present invention.

As shown in FIG. 3, the filter housing cap for water purifier according to the second embodiment of the present invention is the same as that of one embodiment of the present invention except for a passage 230. The passage 230 includes a first extension passage 230a extending from any one engagement portion 211 upward, a second extension passage 230b extending from another engagement portion 213 upward, and a connection passage 230c formed at a level with a body 200 and allowing the first extension passage 230a and the second extension passage 230b to be connected to each other.

The connection passages 130b and 230c of the passages 130 and 230 according to the first and the second embodiment of the present invention and the bodies 100 and 200 may be formed at the same time during the molding or the connection passages 130b and 230c of the passages 130 and 230 may be formed next to the molding of the bodies 100 and 200.

In case of the first embodiment, the connection passage 130b may be formed by using a drill and so on next to the molding of the body 100 or the connection passage 130b and the body 100 may be integrally formed by inserting a pipe (not shown) into the mold during the molding of the body 100. In case of the second embodiment, since the connection passage 230c is bended, it is more or less difficulty to be formed by using the drill and so forth. Accordingly, it is preferred that the connection passage 230c and the body 200 are integrally formed by inserting a pipe of one-bended shape (not shown) into the mold during the molding of the body 200.

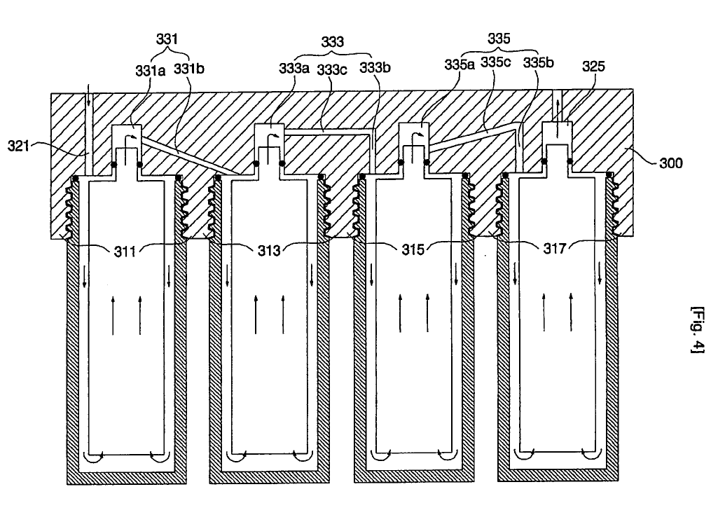

FIG. 4 is a sectional view illustrating a filter housing cap for water purifier according to a third embodiment of the present invention.

As shown in FIG. 4, the filter housing cap for water purifier according to the third embodiment of the present invention includes four engagement portions 311, 313, 315 and 317 formed at a body 300 in a straight line. An inlet 321 for inflowing the original water is formed at the first engagement portion 311 and an outlet 325 for discharging the purified water is formed at the fourth engagement portion 317. Also, the first and second engagement portions 311 and 313 are communicated with each other by means of a first passage 331 having an extension passage 331a and a connection passage 331b downwardly slanted on the body 300. The second and third engagement portions 313 and 315 are communicated with each other by means of a second passage 333 having a first extension passage 333a, a second extension passage 333b and a horizontal connection passage 333c. Also, the third and fourth engagement portions 315 and 317 are communicated with each other by means of a third passage 335 having a first extension passage 335a, a second extension passage 335b and a connection passage 335c upwardly slanted on the body 300. Here, the construction of the first passage 331 is the same as that of the passage 130 of FIG. 2 and the construction of the second passage 333 is the same as that of the passage 230 of FIG. 3. Also, the construction of the first passage 331 is a mixed construction of the passages 130 and 230 shown in FIG. 2 and FIG. 3.

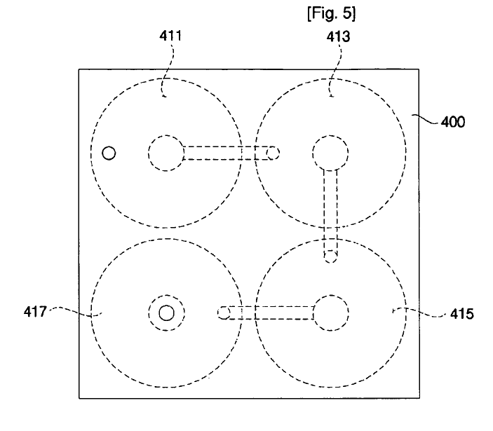

FIG. 5 is a planar view illustrating a filter housing cap for water purifier according to a fourth embodiment of the present invention.

As shown in FIG. 5, the filter housing cap for water purifier according to the fourth embodiment of the present invention includes four engagement portions 411, 413, 415 and 417 formed at a body 400 at a right angle, not in a straight line. Accordingly, it can implement the integrated filter housing cap.

### INDUSTRIAL APPLICABILITY

The present invention relates to a filter housing cap for water purifier including a plurality of engagement portions for engaging with housings having a filter, an inlet for water and an outlet for water formed at any one engagement portion and another engagement portion respectively, and a passage reciprocally communicated with the engagement portions and formed at the cap itself, whereby the shape and the manufacturing process thereof is simple.

While this invention has been described in connection with what are presently considered to be the most practical and preferred embodiments, it is to be understood that the invention is not limited to the disclosed embodiments and the drawings, but, on the contrary, it is intended to cover various modifications and variations within the spirit and scope of the appended claims.

1. A filter housing cap for water purifier comprising:
a body coupled to a water purifier body;
a plurality of engagement portions formed at one surface of the body coupled to the water purifier body and attached and deattached to housings having a filter, respectively;
an inlet formed at the body coupled to the water purifier body in such a manner that it is communicated with any one engagement portion among the engagement portions and an original water is guided and flowed to the filter of the housing coupled to said any one engagement portion;
a passage formed at the body coupled to the water purifier body in such a manner that one side thereof is communicated with said any one engagement portion, another side thereof is communicated with another engagement portion, and the original water, which is passed through the filter of the housing coupled to said any one engagement portion, is guided and flowed to the filter coupled to said another engagement portion; and
an outlet formed at the body coupled to the water purifier body in such a manner that it is communicated with said another engagement portion and the original water, which is passed through the filter of the housing coupled to said another engagement portion, is guided and discharged to an usage place.

2. A filter housing cap for water purifier as claimed in claim 1, wherein the passage comprises an extension passage extending from said any one engagement portion upward and a connection passage for connecting the extension passage to said another engagement portion.

3. A filter housing cap for water purifier as claimed in claim 1, wherein the passage comprises a first extension passage extending from said any one engagement portion upward, a second extension passage extending from said another engagement portion upward, and a connection passage for connecting the first extension passage to the second extension passage.
